(19) United States
(12) Patent Application Publication
(10) Pub. No.: US 2008/0163458 A1
(43) Pub. Date: Jul. 10, 2008

(54) Power transmission apparatus

(75) Inventors: Dong-Won Choi, Suwon-si (KR); Chil-Sung Lee, Suwon-si (KR); Jae-Kyung Kim, Ansan-si (KR); Jae-Hun Kim, Suwon-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,046

(22) Filed: Jan. 4, 2008

(30) Foreign Application Priority Data
Jan. 8, 2007 (KR) 10-2007-0001987

(51) Int. Cl. E05D 11/08

(52) U.S. Cl. 16/338

(57) ABSTRACT

A power transmission apparatus is disclosed. A power transmission apparatus that includes: a bracket, in which a hinge cavity is formed; a hinge axis, which is rotatably joined to the hinge cavity; a friction bearing, which is positioned between the hinge axis and an inner wall of the hinge cavity, and which is configured to provide a predetermined friction; and a gear module, which is joined to the hinge axis, and which is configured to provide a rotational force to the hinge axis, can provide sufficiently high deceleration and high torque, even when a low-capacity motor having a low cogging torque is used. Also, the power transmission apparatus can be made safer and less noisy for not only automatic operation by the motor but also manual operation by a user, while the gear module, motor, etc., can be protected from excessive loads.

### CROSS-REFERENCE TO RELATED APPLICATIONS

This application claims the benefit of Korean Patent Application No. 10-2007-0001987 filed with the Korean Intellectual Property Office on Jan. 8, 2007, the disclosure of which is incorporated herein by reference in its entirety.

### BACKGROUND

1. Technical Field

The present invention relates to a power transmission apparatus.

2. Description of the Related Art

A gear module joined to a motor may serve to reduce the rotational speed transferred from the motor by a particular rate. Multiple gears can be arranged in a gear module, with the rotation of the motor decelerated by the combination of these gears.

Rotating a mass such as a television or computer monitor, however, requires high torque, although a high rotational speed may not be necessary. Thus, as the high rotational speed of the motor has to be reduced to several to several tens of revolutions per minute, a sufficient degree of deceleration may not be achieved with only a gear module, and it may be difficult to obtain high levels of torque.

Furthermore, if the television or computer monitor is rotated, not by the electrical driving of the motor, but by an external force from the user, an excessive load may be imposed on the motor connected to the rotational axis, causing damage to the motor.

In addition, when a mass rotated automatically using a motor having a gear module is stopped from rotating, there is a risk of the mass shaking, due to the backlash between gears within the gear module and other tolerances in each assembly part.

### SUMMARY

An aspect of the invention is to provide a power transmission apparatus, which can provide high deceleration and high torque, even when a low-capacity motor having a low cogging torque is used.

Another aspect of the invention is to provide a power transmission apparatus, which is safe against rotating by the user, as well as for automatic rotation by the driving of the motor, and which provides less noise.

Yet another aspect of the invention is to provide a power transmission apparatus, which prevents shaking in the mass.

One aspect of the invention provides a power transmission apparatus that includes: a bracket, in which a hinge cavity is formed; a hinge axis, which is rotatably joined to the hinge cavity; a friction bearing, which is positioned between the hinge axis and an inner wall of the hinge cavity, and which is configured to provide a predetermined friction; and a gear module, which is joined to the hinge axis, and which is configured to provide a rotational force to the hinge axis.

In certain embodiments of the invention, if a link member is joined to a portion of the hinge axis, a washer may additionally be interposed between the bracket and the link member to control a friction of the hinge axis. Also, a friction hinge may be interposed between the hinge axis and the gear module that is configured to engage and disengage the rotational force outputted from the gear module.

In addition, a worm gear module may further be included between the hinge axis and the gear module, where the worm gear module may be configured to decelerate a rotational speed outputted from the gear module by a predetermined rate. In this case, a friction hinge interposed between the hinge axis and the worm gear module may further be included, which is configured to engage and disengage the rotational force outputted from the worm gear module.

A friction torque provided by the predetermined friction can be greater than a torque provided by a rotational inertia of the hinge axis. Also, a friction torque provided by the predetermined friction can be smaller than an operation requirement torque of the hinge axis.

The friction bearing may include Teflon or a synthetic resin. Also, the friction bearing may include a metal plate coated with Teflon.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a power transmission apparatus according to an embodiment of the present invention.

FIG. 2 is a cross-sectional view of a power generation part according to an embodiment of the present invention.

FIG. 3 is a cross-sectional view of a friction hinge according to an embodiment of the present invention.

FIG. 4 is a perspective view of a rotational movement apparatus according to an embodiment of the present invention.

FIG. 5 is a schematic drawing illustrating the composition of a rotational movement apparatus according to an embodiment of the present invention.

### DETAILED DESCRIPTION

The power transmission apparatus according to certain embodiments of the invention will be described below in more detail with reference to the accompanying drawings, in which those components are rendered the same reference numeral that are the same or are in correspondence, regardless of the figure number, and redundant explanations are omitted.

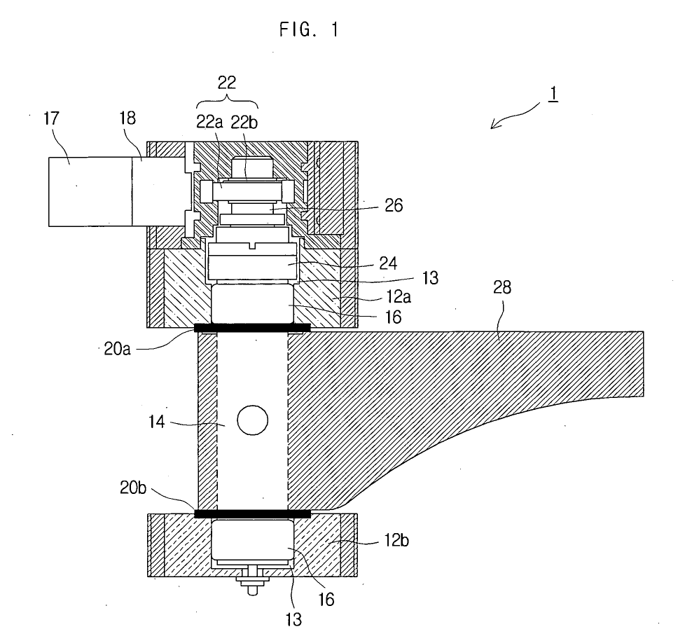

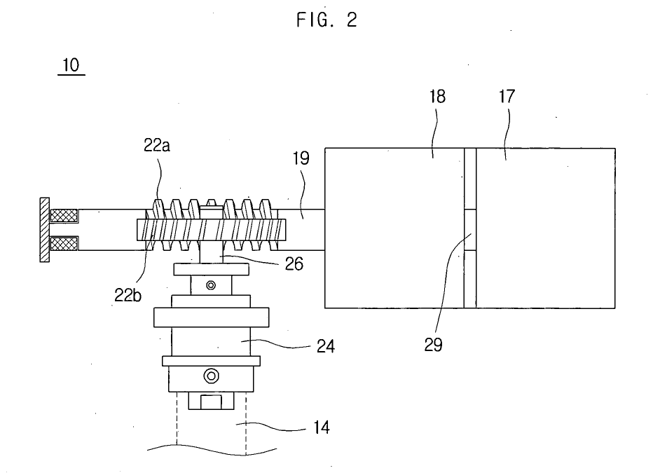

FIG. 1 is a cross-sectional view of a power transmission apparatus according to an embodiment of the present invention, and FIG. 2 is a cross-sectional view of a power generation part according to an embodiment of the present invention. In FIG. 1, and FIG. 2, there are illustrated a power transmission apparatus 1, a power generation part 10, brackets 12a, 12b, hinge cavities 13, a hinge axis 14, friction bearings 16, a gear module 18, a main axis 19, washers 20a, 20b, a worm gear module 22, a worm 22a, a worm gear 22b, a friction hinge 24, an output axis 26, a link member 28, and a drive axis 29.

The brackets 12a, 12b may rotatably support the hinge axis 14. For this, hinge cavities 13 may be formed in the brackets 12a, 12b, where a portion of the hinge axis 14 may be inserted in a hinge cavity 13 such that the hinge axis 14 is rotatably joined in the hinge cavities 13. A certain member can be joined to the hinge axis 14, so that the rotation of the hinge axis 14 may rotate the certain member. This member can be the link member 28, which may have one end joined to the hinge axis and the other end joined with a mass, such as a display 54. In this case, by rotating the hinge axis 14, the link member 28, of which one end is joined to the hinge axis 14, may be rotated about the hinge axis 14, so that the mass joined to the other end of the link member 28 may in turn be rotated. Here, since the position of the hinge axis 14 may be altered, or the mass may not be moved to the correct position when the link member 28 is rotated, if the mass joined to the other end of the link member 28 is heavy, the brackets 12a, 12b may be such that correctly supports the hinge axis 14. Also, in some cases where a motor 17 having a gear module 18 is used to automatically rotate the mass, stopping the motor 17 can cause the mass to shake, due to the rotational inertia of the mass and the backlash between gears in the gear module 18 and other tolerances in each assembly part. To prevent this, an embodiment of the invention may employ friction bearings 16, which provide a particular level of friction, between the hinge axis 14 and the inner walls of the hinge cavities 13 formed in the brackets 12a, 12b.

The friction torque provided by the friction bearings 16, interposed between the hinge axis 14 and the hinge cavities 13 to create a particular level of friction, can be made greater than the torque provided by a rotational inertia of the hinge axis 14. Here, friction torque refers to the torque provided by the maximum halting friction of the friction bearing 16 on the hinge axis 14, while the rotational inertia of hinge axis 14 refers to the inertial force created by the rotation of the hinge axis 14. The rotational inertia can be great when one end of the link member 28 is joined to the hinge axis 14 and a mass is joined to the other end of the link member 28. Thus, by having the friction torque greater than the torque provided by the rotational inertia of the hinge axis 14, the shaking of the mass due to the backlash between gears within the gear module 18 and other tolerances in each assembly part can be avoided. On the other hand, the friction torque can be made smaller than the operation requirement torque of the hinge axis 14. Here, the operation requirement torque of the hinge axis 14 refers to the torque required to rotate the hinge axis 14, and by making the operation requirement torque smaller than the friction torque, the hinge axis 14 can be rotated by the rotational force provided from the worm gear module 22.

A metal plate coated with Teflon can be used as the material for the friction bearing 16, and if the rotational force provided to the hinge axis is relatively weak, a friction bearing made of Teflon or a synthetic resin may also be used.

In cases where a link member 28 is joined to a portion of the hinge axis 14, as illustrated in FIG. 1, it is possible to additionally interpose washers 20a, 20b between the brackets 12a, 12b and the link member 28, to control the friction on the hinge axis 14.

The brackets 12a, 12b may be for supporting the hinge axis 14, and thus multiple brackets 12a, 12b may be used. In this particular embodiment, two brackets 12a, 12b are used to support either end of the hinge axis 14.

The hinge axis 14 may serve as an axis of rotation for a certain member (e.g. the link member 28), and the power generation part 10 may be joined to the hinge axis 14 to move the certain member by automatically rotating the hinge axis 14.

The power generation part 10, which provides a particular rotational force on the hinge axis 14, can be composed of a motor 17, a gear module 18 that decelerates the rotational speed of the motor 17 by a particular rate, a worm gear module 22 that reduces the decelerated rotational force to a particular rotational speed, and a friction hinge 24 joined to the output axis 26 of the worm gear module 22 (see FIG. 2).

The drive axis 29 of the motor 17 may be joined to the gear module 18, to reduce the rotation speed of the motor 17 by a particular rate, and may be joined again to the worm gear module 22, which may include a worm 22a and worm gear 22b, for a secondary deceleration. The resulting rotational force may then be provided to the hinge axis 14.

The gear module 18 may be such that is joined to the motor 17 to decelerate by a predetermined rate the rotational speed transferred from the motor 17. Multiple gears may be arranged in the gear module 18, the combination of which may act together to reduce the rotational speed of the motor 17.

A common motor 17 produces a high rotational speed, such as of about 3000 rpm. In contrast, the rotational speed required in an apparatus for automatically rotating a display, such as an LCD (liquid crystal display) or a PDP (plasma display panel), is between several to several tens of revolutions per minute. As such, a high rotational speed may not be necessary, but instead a high torque may generally be required.

In interposing the gear module 18, a drive pinion (not shown) may be equipped at the end of the drive axis 29 of the motor 17. The combination of multiple gears within the gear module 18 may receive the rotational force transferred by the drive pinion and reduce the rotational speed of the motor 17 by a predetermined rate, with the resulting force transferred through the main axis 19 of the gear module 18.

The worm gear module 22 may include a worm 22a and a worm gear 22b. An output axis 26 may be joined at the center of the worm gear 22b that provides a rotational force to the hinge axis 14 after it is decelerated by the gear module 18 and the worm gear module 22 described above. The worm 22a may be joined to the main axis 19 of the gear module 18, to transfer the rotational force to the worm gear 22b meshed with the worm 22a. The worm 22a may be a separate device that is joined with the main axis 19, or the worm 22a may be formed along the perimeter of the main axis 19 and integrated as a single body with the main axis 19.

While it is possible to decelerate the rotational speed of the motor 17 by a predetermined rate using the gear module 18, the rotation in an apparatus for rotating a display requires a high torque, as well as a low speed. Using numerous gears within the gear module 18 to obtain such high deceleration rate and high torque can create a risk of large backlash within the gear module 18. When a mass such as a display, etc., is stopped from rotating, such backlash can cause shaking of the mass. Thus, in this embodiment, the worm 22a and the worm gear 22b are used, so that after the gear module 18 primarily decelerates the rotational speed of the motor 17, the worm 22a and the worm gear 22b may secondarily decelerate the rotational speed primarily decelerated by the gear module 18, thereby providing not only a high deceleration rate but also a high torque. The arrangement of the worm 22a and worm gear 22b can also reduce backlash in the gear module 18. Furthermore, the worm 22a and worm gear 22b can alter the direction in which the rotational force of the motor 17 may be provided, whereby the power generating part 10 can be positioned with greater freedom without obstructing the rotating position of a mass, such as a display, etc.

As a very high load is generally applied on the worm 22a, the worm 22a can be formed using forged carbon steel or nickel chromium steel, etc. The forged carbon steel can be used by annealing SF490A, SF540A, or SF590A, etc., while nickel chromium steel can be used by quenching SNC631, SNC836, etc. The worm gear 22b can be formed using bronze casting or phosphor bronze casting, which may produce a structure that is not as hard as the worm 22a.

However, if the rotation speed of the motor 17 can be reduced by the gear module 18 by a particular deceleration rate, and if there is a low risk of problems due to backlash, it may be possible to transfer the rotational force of the gear module 18 directly to the hinge axis 14, with the worm gear module 22 omitted.

The friction hinge 24 may be joined with the output axis 26 of the worm gear 22b to engage and disengage the rotational force of the output axis 26. The friction hinge 24 may include an active axis, which joins with the output axis 26 of the worm gear 22b, and a passive axis, which faces the active axis, where the friction between the active axis and passive axis can be controllable. The controlling of the friction between the active axis and passive can be to determine whether to engage or disengage the transfer of the rotational force of the output axis 26. The rotational force engaged by this friction hinge 24 can be transferred to the hinge axis 14, whereby the rotation of the hinge axis 14 can be controlled.

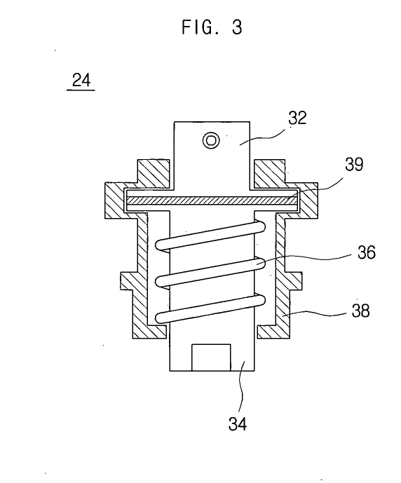

In cases where the rotational force of the gear module 18 is transferred directly to the hinge axis 14 with the worm gear module 22 omitted, the friction hinge 24 can be interposed between the gear module 18 and the hinge axis 14, to engage and disengage the rotational force outputted from the gear module 18. The friction hinge 24 will be described in greater detail with respect to FIG. 3.

FIG. 3 is a cross-sectional view of a friction hinge according to an embodiment of the present invention. In FIG. 3, there are illustrated a friction hinge 24, an active axis 32, a passive axis 34, an elastic member 36, a housing 38, and a washer 39.

The friction hinge 24 may be interposed between the hinge axis and the worm gear module, and may engage and disengage the rotational force outputted from the worm gear module. However, it is possible to interpose the friction hinge 24 between the hinge axis and the gear module to engage and disengage the rotational force outputted from the gear module, with the worm gear module omitted.

In this particular embodiment, the rotation speed of the output axis of the worm gear may be primarily decelerated by a gear module joined to the motor, and secondarily decelerated by the worm and worm gear joined to the gear module. Thus, the friction hinge 24 will be described for the case where the friction hinge 24 is positioned between the hinge axis and the worm gear module to engage and disengage the rotational force outputted from the worm gear module.

The friction hinge 24 may be joined to the output axis of the worm gear to engage and disengage the rotational force of the output axis. The friction hinge 24 may include an active axis 32, which receives the driving force transferred from the output axis of the worm gear, and a passive axis 34 facing the active axis 32. For plane contact between the active axis 32 and passive axis 34, a flange may be formed at the opposing surface of each of the active axis 32 and passive axis 34.

The friction may be controllable between the active axis 32 and passive axis 34. This controllable friction between the active axis 32 and passive axis 34 can be used to engage and disengage the rotational force of the output axis of the worm gear. To thus control and maintain the friction, an elastic member 36 can be interposed to control the degree of contact between the active axis 32 and the passive axis 34. In this embodiment, a coil spring may be inserted onto the passive axis 34 which may provide an elastic force, with the supporting points at the flange of the passive axis 34 and the housing 38, to keep the active axis 32 and passive axis 34 in close contact.

In order to transfer the rotational force of the output axis of the worm gear via the active axis 32 of the friction hinge 24 to the passive axis 34, the torque provided by to the friction between the active axis 32 and passive axis 34 may have to be greater than the torque provided by the output axis. If the torque provided by to the friction between the active axis 32 and passive axis 34 is smaller than the torque provided by the output axis 26 of the worm gear, the rotational force of the output axis 26 may not be completely transferred to the passive axis 34 of the friction hinge 24. Using this principle, the friction between the active axis 32 and passive axis 34 may be controlled to engage and disengage the rotational force of the output axis 26.

Protrusions (not shown) having a certain degree of roughness can be formed on the opposing surfaces of the active axis 32 and passive axis 34 to provide a certain level of friction. In addition, to control the friction between the active axis 32 and the passive axis 34, a washer 39 may be interposed between the opposing surfaces of the active axis 32 and passive axis 34, where multiple washers 39 may be used as necessary to control the level of friction.

As such, the friction between the active axis 32 and passive axis 34 can be controlled using the friction hinge 24. Then, the driving of the motor can provide automatic rotation, and should there be a forced rotation of the hinge axis joined to the friction hinge 24 while the motor 17 is not under operation, slipping may occur between the active axis 32 and passive axis 34 of the friction hinge 22, so that the worm gear module, the gear module, and the motor may not be damaged due to an excessive load.

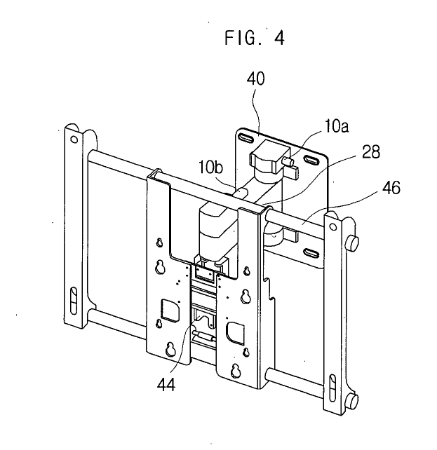

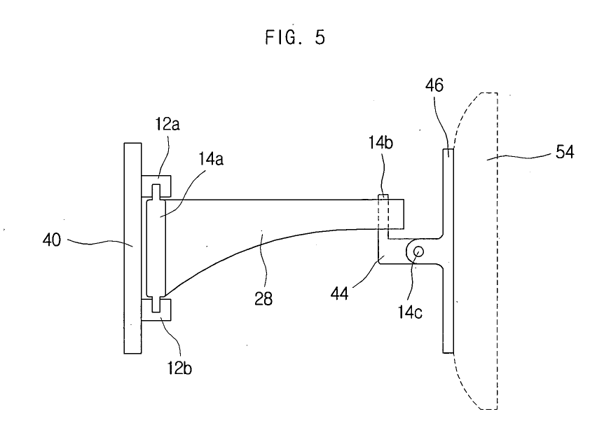

FIG. 4 is a perspective view of a rotational movement apparatus according to an embodiment of the present invention, and FIG. 5 is a schematic drawing illustrating the composition of a rotational movement apparatus according to an embodiment of the present invention. In FIG. 4 and FIG. 5, there are illustrated a fixed body 40, a link member 28, a connector 44, a movable body 46, a first hinge axis 14a, a second hinge axis 14b, a third hinge axis 14c, a first power generation part 10a, a second, power generation part 10b, and a display 54.

The rotational movement apparatus based on this embodiment may include a fixed body 40, a link member 28 having one end hinge-joined to the fixed body about a first hinge axis 14a, a connector 44 hinge-joined to the other end of the link member 28 about a second hinge axis 14b, and a movable body 46 hinge-joined with the connector 44 about a third hinge axis.

A power generation part 10a, 10b can be joined to each of the first through third hinge axes respectively, which can provide a rotational force to each hinge axis 14a, 14b, 14c and thus move the display 54 joined to the movable body 46 to a particular position.

The first hinge axis 14a and the second hinge axis 14b can be in a substantially parallel configuration, while the second hinge axis 14b and the third hinge axis 14c can be in a substantially perpendicular configuration, to not only allow translational movement of the movable body 46 with respect to the fixed body 40, but also allow rotation of the movable body 46 in the left, right, upward, and downward directions.

In the rotational movement apparatus of this particular embodiment, the fixed body 40 may be secured to a wall, and a display 54, such as an LCD and PDP, etc., may be secured to the movable body 46. In this way, the movable body 46 can be moved in a translational manner or rotated in the left, right, upward, and downward directions, such that the front of the display 54 faces a direction desired by the user.

Looking at the method of rotation in the rotation apparatus according to this embodiment for automatic operation, the first power generation part 10a joined to the first hinge axis 14a, which may be secured to one end of the link member 42, may rotate the first hinge axis 14a to rotate the link member 42 about the first hinge axis 14a, thereby allowing translational motion for the movable body 46. The second power generation part 10b joined to the second hinge axis 14b, which may be secured to the connector 44, may rotate the second hinge axis 14b, thereby allowing the movable body 46 to rotate left and right about the second hinge axis 14b. The third power generation part (not shown) joined to the third hinge axis 14c, which may be secured to the movable body 46, may rotate the third hinge axis 14c, thereby allowing the movable body 46 to rotate up and down about the third hinge axis 14c.

The power transmission apparatus, which is joined to one end of the link member 28 and which includes the first hinge axis 14a, allows the movable body 46 to rotate left and right about the first hinge axis 14a. When a mass, such as the display 54, etc., is joined to the movable body 46, stopping the mass while it is moving can cause shaking of the mass, due to the rotational inertia of the mass and the backlash between gears in the gear module 18 and other tolerances in each assembly part. To prevent this, an embodiment of the invention may employ friction bearings, which provide a particular level of friction, between the first hinge axis 14a and the inner walls of the hinge cavities formed in the brackets 12a, 12b, so that the display 54 can be prevented from shaking due to the rotational inertia.

According to certain embodiments of the invention as set forth above, sufficiently high deceleration and high torque can be obtained, even when a low-capacity motor having a low cogging torque is used. Also, the power transmission apparatus can be made safer and less noisy for not only automatic operation by the motor but also manual operation by a user, while the gear module, motor, etc., can be protected from excessive loads.

Moreover, a mass such as a display can be prevented from shaking due to backlash between gears within the gear module and other tolerances in each assembly part.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A power transmission apparatus comprising:
a bracket having a hinge cavity formed therein;
a hinge axis rotatably joined to the hinge cavity;
a friction bearing interposed between the hinge axis and an inner wall of the hinge cavity and configured to provide a predetermined friction; and
a gear module joined to the hinge axis and configured to provide a rotational force to the hinge axis.

2. The power transmission apparatus of claim 1, wherein a link member is joined to a portion of the hinge axis, and
a washer is interposed between the bracket and the link member for controlling a friction of the hinge axis.

3. The power transmission apparatus of claim 1, further comprising:
a friction hinge interposed between the hinge axis and the gear module, the friction hinge configured to engage and disengage the rotational force outputted from the gear module.

4. The power transmission apparatus of claim 1, further comprising:
a worm gear module interposed between the hinge axis and the gear module, the worm gear module configured to decelerate a rotational speed outputted from the gear module by a predetermined rate.

5. The power transmission apparatus of claim 4, further comprising:
a friction hinge interposed between the hinge axis and the worm gear module, the friction hinge configured to engage and disengage the rotational force outputted from the worm gear module.

6. The power transmission apparatus of claim 1, wherein a friction torque provided by the predetermined friction is greater than a torque provided by a rotational inertia of the hinge axis.

7. The power transmission apparatus of claim 1, wherein a friction torque provided by the predetermined friction is smaller than an operation requirement torque of the hinge axis.

8. The power transmission apparatus of claim 1, wherein the friction bearing includes Teflon or a synthetic resin.

9. The power transmission apparatus of claim 1, wherein the friction bearing includes a metal plate coated with Teflon.
